(19) United States
(12) Patent Application Publication
(10) Pub. No.: US 2006/0145367 A1
(43) Pub. Date: Jul. 6, 2006

(54) Performance augmentation of natural draft cooling towers

(76) Inventors: Giacomo Gasparini, Victoria (AU); Giovanni Barbieri, Victoria (AU)

Correspondence Address: BIRCH STEWART KOLASCH & BIRCH, PO BOX 747, FALLS CHURCH, VA, 22040-0747, US

(21) Appl. No.: 10/525,432

(22) PCT Filed: Aug. 26, 2003
(86) PCT No.: PCT/AU03/01083

§ 371 Date: Sep. 13, 2005

(30) Foreign Application Priority Data
Aug. 26, 2002 (AU) 2002951017

(51) Int. Cl. B01D 47/00

(52) U.S. Cl. 261/109

(57) ABSTRACT

A method and apparatus are provided for enhancing the performance capability of an existing natural draft cooling tower(13). The cooling tower includes a structure (14) defining an open-topped internal passage (15) ofcircular cross section for the upward flow of air from one or more inlets (16) at the base of the structure. The method includes steps of providing within the passage (15), an impeller (27) adapted when mtated at a specified speed about an upright axis of rotation (28) centrally located in the passage to increase the overall flow rate of air in the passage beyond the overall flow rate obtainable in the same operatiny conditions by natural draft alone and provides support means for said impeller and drive means capable of rotating the impeller at the specified speed. The impeller (27) is supported by the supporn means above heat transfer means (19) (which may be a wetted packiny structure) of the cooling tower (13).

### FIELD OF THE INVENTION

This invention relates to a method and apparatus for augmenting the performance of natural draft cooling towers, a cooling tower with variable cooling capacity and a method of enhancing the performance of a power generating system fitted with a natural draft cooling tower.

### BACKGROUND

Cooling towers are heat exchangers of a type widely used for rejection of low grade heat to atmosphere, in electricity generation, air conditioning installations and the like. This invention is directed to large capacity natural draft cooling towers such as those used in electric power generation. These are built in very large sizes, for lowering the temperature of condenser cooling water. Such cooling towers have been built with tower heights over 100 m and base diameters over 90 m. Such cooling towers may have design cooling water flow rates in the order 5 to 50 m³/s or more.

In a natural draft cooling tower for this application, air flow is induced in a hollow chimney-like tower by the density difference between cool air entering the bottom of the tower and warm air leaving the top, due to heat transfer from the water being cooled, which is passed through the interior of the tower. Most such cooling towers are “wet” types, in which there is direct contact between water being cooled and the flowing air, so that a proportion of the water evaporates. The tower itself is typically a hollow, open-topped shell of reinforced concrete with an upright axis of symmetry and circular cross-section, the shell wall having a necked, hyperbolic shape when seen in meridian cross-section. Openings at the base of the tower structure enable ingress of air. The convergent-divergent shape aids in inducing the natural draft.

“Dry” type natural draft cooling towers are also known, in which the fluid to be cooled remains isolated from the cooling air, together with hybrid wet/dry types.

Forced draft cooling towers are also known, in which the air flow is produced by fans. In these devices, there is generally no true tower structure similar to the open-topped shell of a large natural draft cooling tower, because the fans replace the chimney effect of the natural draft cooling towers.

It is also known to provide large cooling towers, with hyperbolic shells as in the large natural draft cooling towers, but with forced draft or fan augmentation of natural draft. These use multiple, high-speed fans, and are comparatively complex and expensive by comparison with simple natural draft cooling towers. See for example U.S. Pat. 3,903,212 and British Patent 1455544. Further, such arrangements are generally not suitable for modification of existing installations.

Once a natural draft cooling tower has been built, its performance for a given set of atmospheric conditions (temperature, humidity and wind), water flow rate and temperature is essentially fixed. Cooling towers are designed to achieve a specified performance at specified “design-point” conditions. Only physical changes to the cooling tower arrangement would change its performance characteristics. For example, changes to the ”packing” of a wet-type natural draft cooling tower (i.e. the large-surface-area structure at its base which is wetted by the fluid to be cooled and which extends the residence time of that water in the cooling tower, can affect cooling capacity to a significant degree. However, this is not done as a routine matter: if an improved packing design is developed, it may be implemented as a “one off” improvement if cost-effective. Generally, the options for economically improving or varying existing cooling tower performance are very limited.

It is known that improving cooling tower performance (i.e. the ability to extract an increased quantity of waste heat in a given time) can lead to improved overall efficiency of a steam plant's conversion of heat to electric power and/or to increases in power output in particular conditions. Cost-effective methods of improvement are desired, particularly in already-existing plant. The present invention addresses this desire. Equivalent considerations can apply in other industries where large natural draft cooling towers are used.

Large natural draft cooling towers are high-capital-cost, long-life fixed constructions, and it is desirable that improvements be obtainable without major modifications, particularly to the main tower structure. The method and apparatus of the present invention are applicable to the improvement of existing natural draft cooling towers, as well as to new cooling towers. The modification of existing towers may in fact be the main application area of the invention.

The present invention also provides for a degree of readily controllable variation of cooling tower performance to be obtained.

### SUMMARY OF THE INVENTION

Surprisingly, it has been found in suitable cases to be feasible and worthwhile to economically enhance the performance of large natural draft cooling towers having a circular cross-section by providing for augmentation of the natural draft by a rotating impeller (fan) within the cooling tower structure which in use spans substantially the whole internal diameter of the cooling tower, or a large proportion thereof. Cooling towers to which the invention is applicable include, in particular, those of such large size that the use of fans to provide or augment the draft of air has been considered impractical or too expensive to be cost-effective, particularly in retrofit applications. The invention is applicable to both new and existing cooling towers, but offers in particular the possibility of upgrading an existing cooling tower without greatly affecting the packing, and requiring comparatively limited space for new equipment inside and outside the existing structure.

According to the invention, there is provided, in a first aspect, a method for enhancing the performance capability of an existing natural draft cooling tower, wherein the cooling tower:

(a) is adapted including by size and cooling capacity in natural draft operation for use as a natural draft cooling tower in electric power generating station application,

(b) includes a structure defining an internal passage of circular cross-section for the upward convectional flow of an air steam therein from air inlet openings at or near a lower part of the structure to an outlet opening at the top of the structure, and

(c) contains heat transfer means in a lower part of said passage for transferring heat from water supplied to said cooling tower to said air,

and wherein said method includes the steps of:

providing within said passage an impeller adapted when rotated at a specified speed about an upright axis of rotation centrally located in said passage in a specified operating condition of said tower to increase the flow rate of air in the passage beyond an overall flow rate obtainable in identical operating conditions by natural draft alone;

providing support means adapted for supporting said impeller within said passage above said heat transfer means; and

providing drive means capable of rotating said impeller at said specified speed.

In a second aspect of the invention, there is provided apparatus for enhancing the performance of a natural draft cooling tower, said apparatus being adapted to use in a cooling tower that:

(a) is adapted including by size and cooling capacity in natural draft operation for use as a natural draft cooling tower in electric power generating station application,

(b) includes a structure defining an internal passage of circular cross-section for the upward convectional flow of an air steam therein from air inlet openings at or near a lower part of the structure to an outlet opening at the top of the structure, and

(c) contains heat transfer means in a lower part of said passage for transferring heat from water supplied to said cooling tower to said air,

and said apparatus including:

an impeller adapted when rotated at a specified speed about an upright axis of rotation centrally located in said passage in a specified operating condition of said tower to increase the flow rate of air in the passage beyond an overall flow rate obtainable in identical operating conditions by natural draft alone;

support means adapted for supporting said impeller within said passage above said heat transfer means, and

drive means capable of rotating said impeller at said specified speed.

In a third aspect of the invention, there is provided a cooling tower for cooling a liquid and having a cooling capacity variable by a user, said cooling tower:

(a) being adapted including by size and cooling capacity in natural draft operation for use as a natural draft cooling tower in electric power generating station application,

(b) including a structure defining an internal passage of circular cross-section for the upward convectional flow of an air steam therein from air inlet openings at or near a lower part of the structure to an outlet opening at the top of the structure,

(c) containing heat transfer means in a lower part of said passage for transferring heat from water supplied to said cooling tower to said air, and

(d) including apparatus as disclosed above and herein for increasing the cooling capacity of said cooling tower when in operation.

In a fourth aspect of the invention, there is provided a method for enhancing the performance of a power generation plant in which:

steam is passed through a turbine which drives an electric power generator and said steam is condensed in a condenser;

cooling water for said condenser is circulated through said condenser and a natural draft cooling tower;

said method including the steps of:

adding to said cooling tower apparatus for enhancing the performance of said cooling tower, said apparatus being apparatus as disclosed above or herein; and

operating said apparatus.

Further preferred further features of the invention are set out in both the appended claims and the detailed description below.

The invention will now be described in more detail, although without any intention to limit the scope of the invention, by reference to the attached Figures, of which:

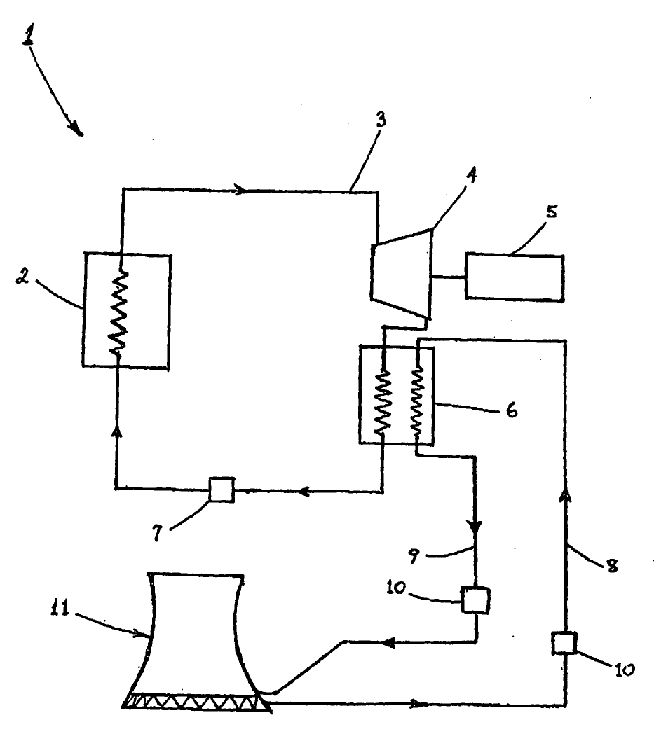

FIG. 1 is a schematic steam/water circuit diagram of a simplified electric power generating installation;

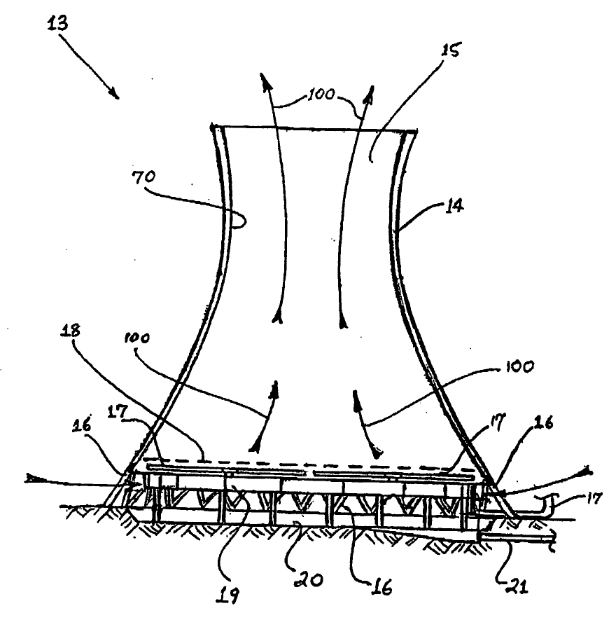

FIG. 2 is a side view of a counterflow-type, “hyperbolic” natural draft cooling tower, seen in vertical cross section, the section being taken at the symmetry axis of the tower structure;

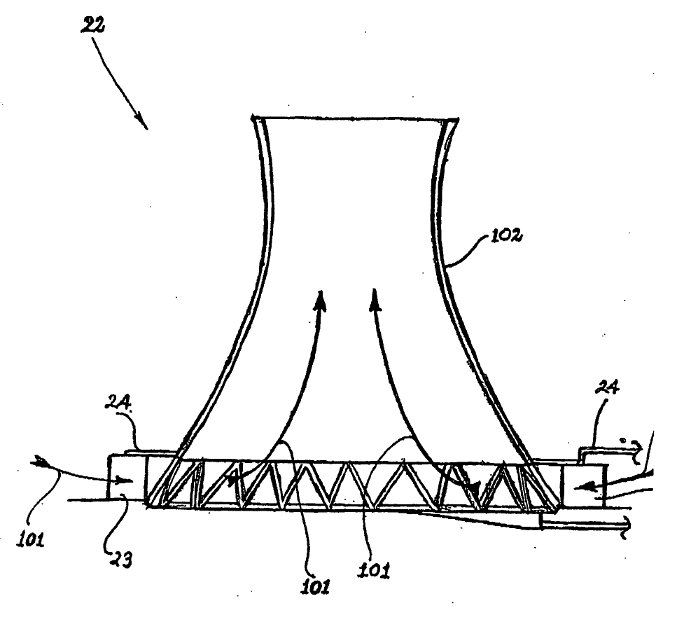

FIG. 3 is a side view of a crossflow-type, “hyperbolic” natural draft cooling tower, seen in vertical cross section, the section being taken at the symmetry axis of the tower structure;

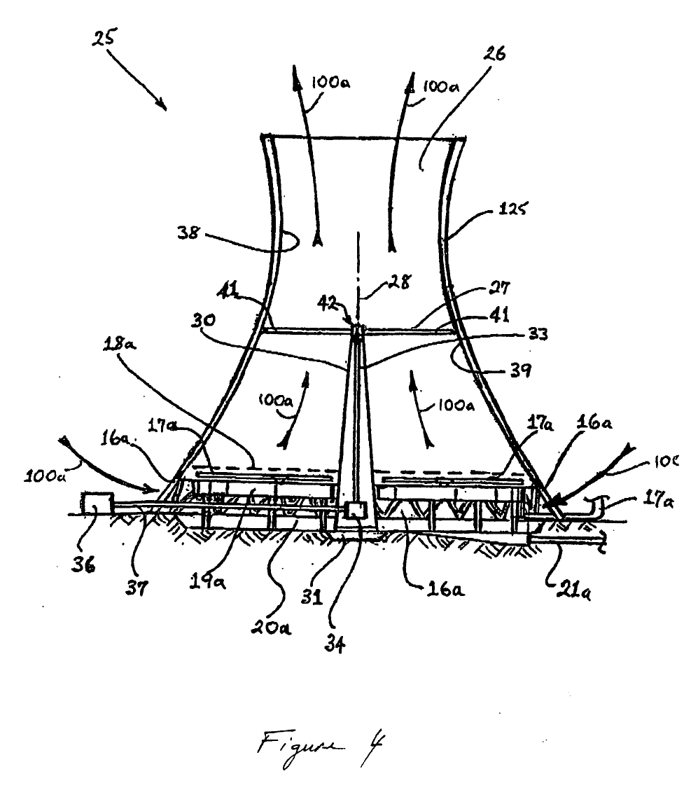

FIG. 4 is a side view of a counterflow-type, “hyperbolic” natural draft cooling tower, embodying the invention, the cooling tower being seen in vertical cross section, taken at the symmetry axis of the tower structure;

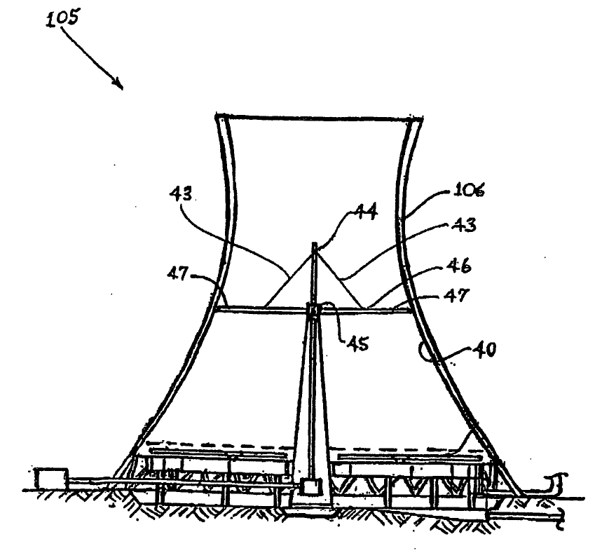

FIG. 5 is a cooling tower embodying the invention in a form that is an alternative to the form shown in FIG. 4, seen in a view that is of the same type as FIG. 4;

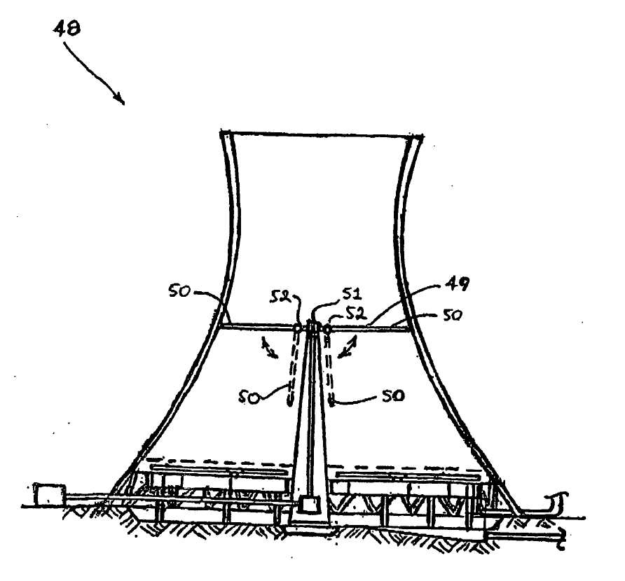

FIG. 6 is a cooling tower embodying the invention in a form that is a further alternative to the form shown in FIG. 4, seen in a view that is of the same type as FIG. 4.

### DETAILED DESCRIPTION OF PREFERRED EMBODIMENTS

FIG. 1 is a schematic diagram of the steam/water circuit 1 of a greatly-simplified electric power generating installation. A boiler 2 produces steam which is led by a duct 3 to a steam turbine 4 which drives a generator 5. The boiler 2 may burn fossil fuel (eg coal or natural gas) to provide heat or the heat source may be a nuclear reactor (not shown). Wet steam exiting the turbine 4 is condensed in a condenser 6 and exits condenser 6 as water, which is recirculated as feedwater to boiler 2 via a feedwater pump 7.

A separate cooling water supply is provided to condenser 6 via a duct 8 and exits in a hotter state via a duct 9, being pumped by cooling water pumps 10. In some installations, a large supply of water is available from a lake, river or artificial “cooling pond” for use as cooling water. However, where this is not the case, cooling water may be directly recirculated as shown in FIG. 1, passing through a cooling tower 11 to lower its temperature before returning to the condenser 6 via duct 8. This arrangement avoids the need for a large natural supply of cooling water, requiring only a fixed quantity of cooling water in circulation and comparatively small amounts (typically 1% to 2% of the cooling water flow) of makeup water to compensate for evaporation losses in the cooling tower 11.

It is to be understood that the circuit 1 is for illustrative purposes only. In a practical power generating installation, (not shown) there would be additional components such as economisers, superheaters, and (usually) multiple boilers and turbines and ducting to accommodate them.

The overall efficiency of circuit 1 and/or the external work done by turbine can be increased by lowering the temperature of cooling water entering the condenser 6. The invention is directed to a method and apparatus for doing this in an existing circuit 1, by modification of cooling tower 11. The invention can also be applied to new cooling towers.

Cooling towers are heat exchangers of the type in which a liquid (in circuit 1, the cooling water) is passed into a space through which a gas (in circuit 1, atmospheric air) is flowing and in that space is cooled by direct contact with the cooler air and by partial evaporation. To give sufficiently long liquid residence times and gas/liquid interface areas, the liquid is often sprayed into the space, falling downward or being splashed onto a large-surface-area fixed structure (known for example as “packing”) at the base of the tower, finally collecting in a basin below the packing and from there leaving the cooling tower. In small cooling towers of the sizes used in air conditioning and similar applications, the flow of gas is normally produced by fans, typically integral with the cooling tower itself. However, in the largest cooling towers, typical of electric power generation applications, natural draft is relied on to provide the airflow.

The following discussion is restricted to “wet-type” natural-draft cooling towers, in which the liquid to be cooled is directly exposed to the air flowing in the tower, this being the most common type found in large sizes such as those typical of electric power generating stations. It is to be understood however that there is no technical obstacle to application of the invention in “dry-type” or hybrid wet/dry natural draft cooling towers.

FIG. 2 shows a counterflow-type, “hyperbolic” natural draft cooling tower 13. A reinforced-concrete wall 14, of hyperbolic shape when seen in meridian section (as in FIG. 2), defines an open-topped passage 15 of circular cross-section through which air flows upwardly from openings 16 spaced peripherally around the base of wall 14. Because the air leaving the top of passage 15 is hotter and less dense than the air entering at the bottom due to heat transfer from the water in the tower 13, a natural draft is induced, as shown by arrows 100, and the hyperbolic shape of the wall 14 enhances this effect. The wall 14 shape gives passage 15 a neck 70, where the internal diameter of passage 15 is at a minimum. Hot inlet water is introduced through pipe system 17. Below a drift eliminator 18, the water is sprayed or splashed downwardly onto and through packing 19 (for which no internal detail is shown) and collects in a depression 20 in the base of the tower 13, finally entering outlet pipes 21. While in the passage 15, the downwardly-moving water is cooled by direct contact with upwardly moving (i.e. counterflowing) air and by partial evaporation.

FIG. 3 shows a crossflow-type natural draft cooling tower 22. This is generally similar to the counterflow-type cooling tower 13, except that the packing 23 (for which no internal detail is shown) is located in an annular ring formation external to, and around the base of, hyperbolic wall 102. The water to be cooled passes downward through the packing 23 from pipe system 24, but the draft of air flowing into the tower 22 moves generally horizontally through the packing 23, as shown by arrows 101, so that there is a crossflow-type interaction between air and water.

The present invention is applicable to both cross-flow and counter-flow natural draft cooling towers as shown (13, 22) in FIGS. 2 and 3. Typically the mean air velocity above the packing in large natural draft cooling towers is in the range 1.2 to 1.8 mls. (See Perry's Chemical Engineers Handbook, 7th Edition, 1997, p12.21.)

FIG. 4 shows a counterflow-type cooling tower 25 similar to cooling tower 13, but to which the present invention has been applied. Within passage 26 defined by the tower structure 125 there is mounted an impeller 27 which can rotate about a vertical axis 28 coaxial with the passage 26. The impeller 27 is secured to a shaft 29 (not shown) coaxial with, and extending upwardly, through a tube 33 in a slender support tower 30 which is mounted on foundation 31 in the water collection pond 20a of the tower 25. This requires modification of only a small proportion of the packing 19a. Impeller 27 has a number of blades 41 extending radially outward from a hub 42.

Item numbers with the suffix “a” correspond to those items in FIG. 2 with the same number and no such suffix.

No structural detail of support tower 30 is shown, as any appropriate construction can be used. Tower 30 is in a position (on the central axis 28) where only minimal restriction to flow of air in the passage 26 is caused. Nevertheless, and also in the interests of minimal maintenance and minimal restriction of air flow, a structure having a smooth external surface (as opposed to an open lattice structure) is preferred. One form (not shown) for tower 30 that is thought to be suitable is an upright tube. Such a tube and its foundation may be designed to have adequate flexural stiffness (i.e. against lateral bending) without any external support, or to be very slender and to have guy wires (or the like) extending outwardly and downwardly from one or more points along it to suitable anchor points.

The support structure must also be designed, and its material(s) selected, for adequate resistance to corrosion in the very wet and warm conditions in passage 26.

It is desirable that the axis of rotation of the impeller (eg 27) be coaxial with the passage 26 so that aerodynamic loads on the impeller blades 41 are substantially constant with time, to avoid possible fatigue loading difficulties.

At the base of tube 33 is a gearbox 34 whereby shaft 29 is driven by an input drive shaft 35 (not shown) which extends horizontally from gearbox 34 to an electric motor 36 external to the tower 25. Shaft 35 is coaxial with, and enclosed in a tube 37. Electric motor 36 drives impeller 27 via shaft 35, gearbox 34 and shaft 29. By enclosing shafts 29 and 35 in tubes 33 and 37, which are secured to gearbox 34, the need for mechanical seals where shafts 29 and 35 enter gearbox 34 is avoided. This is desirable, given the hostile conditions of temperature and humidity in cooling tower 25.

In the preferred embodiment, the electric motor 36 is part of a drive arrangement that can rotate impeller 27 at any of a range of speeds, so that the airflow velocity, hence the cooling capability, of tower 25 can be varied as required.

Impeller 27 is shown as having a swept diameter substantially the same as that of the internal diameter of passage 26 at the height where impeller 27 is mounted, save for a suitable small operating clearance. Neck 38 of passage 26 is a possible place for location of the impeller 27, because it enables provision of the smallest possible impeller 27. Also, because the mean velocity of airflow in passage 26 is highest at the neck 38 of passage 26, experience suggests that that location best lends itself to design for aerodynamic efficiency. However, impeller 27 can be mounted at other heights in passage 26. In FIG. 4 impeller 27 is shown mounted at a lower height, to reduce the height (hence cost) of support 30, albeit at the expense of a larger impeller 27 where the passage 26 is to be substantially fully spanned.

The main reasons for making impeller 27 span essentially the whole width of passage 26 are to enable the whole air flow to be enhanced and to avoid the potential problem of air recirculation within the passage 26. Additionally, the smaller the clearance between impeller 27 and inner surface 39 of hyperbolic wall 125, the higher the attainable aerodynamic efficiency of impeller 27. A suitable operating clearance between blades 41 and surface 39 must always be provided, sufficient to ensure that there is no practical risk of contact between any blade 41 and surface 39.

However, it is within the scope of the invention to provide an impeller (not shown) that is of significantly smaller diameter than the diameter of passage 26 at the vertical location of the impeller. In selecting the impeller diameter, there is a balance to be struck between impeller cost, and its power and structural requirements on one hand, and on the other hand, the need to avoid recirculation in the flow passage (eg 26) and to obtain satisfactory improvement in the overall thermodynamic performance of the cooling tower in a satisfactory range of operating conditions. The optimum compromise can be determined by developing, then analyzing and improving on trial designs, in known fashion.

Impeller 27 can be designed structurally, aerodynamically and aeroelastically using established design methods. Impeller 27 can suitably be of low solidity, having for example 3 to 6 blades 41 of comparatively high aspect ratio (ratio of blade radial length to mean width between leading and trailing edges). That is, the impeller 27 would in some cases resemble a modern “wind turbine” rotor more than the high solidity rotor of an agricultural “windmill” (for example). 3- or 4-bladed impellers may often be found an appropriate choice. However, it is not intended here to in any way limit the scope of the invention to requiring a particular impeller design. The optimum blade design will depend on the particular design parameters for a particular tower.

Blades such as blades 41, of considerable length and slenderness, can now be designed and built, using modern materials and design. The materials—or surface treatments—would need to be such as to resist the wet, corrosive environment and in particular the impact of water droplets.

Blades 41 of impeller 27 are shown in FIG. 4 as being supported only at impeller hub 42. However, it is also within the scope of the invention to provide one or more intermediate supports for each blade as shown in FIG. 5. FIG. 5 shows a cooling tower 105 the same as cooling tower 25 save that wire stays 43 extend outwards and downwards from a mast 44 extending upwards from (and coaxial and arranged to rotate with) hub 45 of an impeller 46. Each stay 43 is secured to one of the blades 47 of impeller 46. It would even be possible to provide for support of each blade (such as 41 or 47) at its outer end by a small roller (not shown) running on a circular track (not shown) added to internal surface 40 of the wall 106.

FIG. 6 shows a cooling tower 48 (similar to cooling tower 25) with an impeller 49 having blades 50 which are mounted to a hub 51 by horizontal-axis hinges 52, so that the blades 50 can move downwardly from their operative positions to more nearly upright positions (shown in phantom lines) and vice versa. Suitable counterweighing (not shown) of each blade 50 radially inward of each hinge can enable the blades 50 to be so balanced that in normal use they will extend substantially horizontally and so that when the impeller 49 is not rotating they pivot to the lowered position. With this arrangement, resistance to purely convective flow of air (i.e. natural draft) is lowered when the impeller 49 is not required to be used or is unserviceable. This arrangement can also provide good access to the blades 50 from support 53 for inspection or maintenance, when blades 50 are in the lowered position. As an alternative to such counterweighing of the blades 50, mechanical equipment (not shown) could readily be provided to actively raise or lower them as required.

A further possibility for reducing resistance to the natural draft when operation of the impeller 27, 46 or 49 is not required is to provide for driving of any of the impellers 27, 46 or 49 at a lower-than-normal speed that minimizes flow losses and requires only limited power input to the impeller drive system. Still nother possibility is to provide for feathering of the blades (41, 47 or 50) when equired, by known means.

In applying the invention, it is desirable to ensure that water collected on the impeller blades (eg 41, 47 or 50) and flung outwards from their tips centrifugally does not cause damage to the adjacent parts of the tower internal surface (eg 39 or 40). One way to avoid this (not shown) is to clad or otherwise protect the relevarit part of the internal surface (eg 39 or 40) with a suitable protective skin. Suitable materials for the skin could include stainless steel or rubber, for example. Such cladding may also be designed to provide protection for the tower structure against damage due to failure of a blade of the rotor. Another possibility (not shown) is to provide conventional end plates or similar formations on the outer ends of the blades, to intercept such water and divert it downward.

Many variations may be made while remaining within the spirit and scope of the invention. Taking cooling tower 25 as an example, the drive for impeller 27 need not be purely electric as shown. It could be hydraulic, with a hydraulic motor at the base or top of support 30 and an electrically driven pump (not shown) outside tower 25. Shaft 35 is eliminated.

It is also possible to provide several impellers within a cooling tower, if required. For example, each impeller could be mounted coaxially with the other(s), an arrangement that would allow each to completely span the passage (eg 26), if required.

Still another possibility (not shown) is to support the impeller not, or not only, on a support such as support tower 30, but from the tower structure 125 (where this is determined to be structurally feasible) or even from a separate structure (not shown) located partly above the tower. The latter possibility might require less downtime for installation of the system.

1-24. (canceled)

25. A method for enhancing the performance capability of an existing wet type natural draft cooling tower, wherein the cooling tower:
(a) is adapted including by size and cooling capacity in natural draft operation for use as a natural draft cooling tower in electric power generating station application,
(b) includes a structure defining an internal passage of circular cross-section for the upward convectional flow of an air stream therein from air inlet openings at or near a lower part of the structure to an outlet opening at the top of the structure, and
(c) contains heat transfer means in a lower part of said passage for transferring heat from water supplied to said cooling tower to said air,
and wherein said method includes the steps of:
providing within said passage an impeller adapted when rotated at a specified speed about an upright axis of rotation centrally located in said passage in a specified operating condition of said tower to increase the flow rate of air in the passage beyond an overall flow rate obtainable in identical operating conditions by natural draft alone, wherein said impeller when rotating at said specified speed spans substantially the entire diameter of said passage at the height of the periphery of said impeller save for a suitable operating radial clearance between said impeller and an internal surface of said passage.
providing support means adapted for supporting said impeller within said passage above said heat transfer means; and
providing drive means capable of rotating said impeller at said specified speed.

26. A method according to claim 25 wherein said heat transfer means includes a packing structure having surfaces arranged to be wetted externally by said water so that heat is transferred from said water by evaporation of a proportion of said water into said air and wherein said method includes the step of securing said support means to at least one of a foundation and a support structure of said packing structure of said cooling tower.

27. A method according to claim 25 wherein one said impeller only is provided in said passage.

28. A method according to claim 25 wherein said impeller is supported by said support means at a height in said passage at least approximately corresponding to the minimum cross-sectional area of said passage.

29. A method according to claim 25 wherein said impeller is supported by said support means at a height in said passage below a height at which said passage is of minimum cross-sectional area.

30. Apparatus for enhancing the performance of a wet type natural draft cooling tower, said apparatus being adapted to use in a cooling tower that:
(a) is adapted including by size and cooling capacity in natural draft operation for use as a natural draft cooling tower in electric power generating station application,
(b) includes a structure defining an internal passage of circular cross-section for the upward convectional flow of an air stream therein from air inlet openings at or near a lower part of the structure to an outlet opening at the top of the structure, and
(c) contains heat transfer means in a lower part of said passage for transferring heat from water supplied to said cooling tower to said air,
and said apparatus including:
an impeller adapted when rotated at a specified speed about an upright axis of rotation centrally located in said passage in a specified operating condition of said tower to increase the flow rate of air in the passage beyond an overall flow rate obtainable in identical operating conditions by natural draft alone, wherein said impeller when rotating at said specified speed spans substantially the entire diameter of said passage at the height of the periphery of said impeller save for a suitable operating radial clearance between said impeller and an internal surface of said passage;
support means adapted for supporting said impeller within said passage above said heat transfer means, and
drive means capable of rotating said impeller at said specified speed.

31. Apparatus according to claim 30 wherein said support means is secured to at least one of a foundation and a support structure of said heat transfer means of said cooling tower.

32. Apparatus according to claim 31 wherein said heat transfer means includes a packing structure having surfaces arranged to be wetted externally by said water so that heat is transferred from said water by evaporation of a proportion of said water into said air.

33. Apparatus according to claim 30 having one impeller only.

34. Apparatus according to claim 30 wherein said support means is adapted to support said impeller at a height in said passage at least approximately corresponding to the minimum cross-sectional area of said passage.

35. Apparatus according to claim 30 wherein said support means is adapted to support said impeller at a height in said passage below a height at which said passage is of minimum cross-sectional area.

36. Apparatus according claim 30 wherein said impeller has a hub and a plurality of blades secured to and in use extending generally radially from said hub.

37. Apparatus according to claim 36 wherein said blades are secured to said hub via pivot means such that each blade is able to be pivoted between an operating position, assumed when said impeller is rotating at said specified speed, and a further position in which an outer end of said blade is lower and radially inward of a position occupied by said outer end when said blade is in said operating position.

38. Apparatus according to claim 38 including means whereby each blade assumes said further position when said impeller is stationary.

39. Apparatus according to claim 36 further including protection means securable to an internal surface of said passage at a position such that when said impeller is rotating at said specified speed, said protection means is adjacent to the outer end of each said blade and adapted to limit damage to said internal surface due to flinging of moisture from said blades.

40. Apparatus according to claim 36 wherein each said blade has a formation at a radially outer end of said blade adapted to limit flinging of moisture collected on said blade onto an internal surface of said passage when said impeller is in said operative position.

41. Apparatus according to claim 30 wherein said drive means includes an electric motor.

42. Apparatus according to claim 41 wherein said electric motor is outside said cooling tower structure and arranged to rotate said impeller via a gear train enclosed in a casing in said cooling tower structure.

43. Apparatus according to claim 41 wherein said electric motor is operable when required as a generator so that if said impeller is rotated by a natural draft within said cooling tower energy can be extracted from said generator.

44. A wet type natural draft cooling tower for cooling a liquid and having a cooling capacity variable by a user, said cooling tower:
(a) being adapted including by size and cooling capacity in natural draft operation for use as a natural draft cooling tower in electric power generating station application,
(b) including a structure defining an internal passage of circular cross-section for the upward convectional flow of an air stream therein from air inlet openings at or near a lower part of the structure to an outlet opening at the top of the structure,
(c) containing heat transfer means in a lower part of said passage for transferring heat from water supplied to said cooling tower to said air, and
(d) including apparatus according to claim 30 for increasing the cooling capacity of said cooling tower when in operation.

45. A method for enhancing the performance of a power generation plant in which:
steam is passed through a turbine which drives an electric power generator and said steam is condensed in a condenser;
cooling water for said condenser is circulated through said condenser and a wet type natural draft cooling tower;
said method including the steps of:
adding to said cooling tower apparatus for enhancing the performance of said cooling tower, said apparatus being apparatus according to claim 30; and operating said apparatus.
